(19) United States
(12) Patent Application Publication
(10) Pub. No.: US 2022/0092748 A1
(43) Pub. Date: Mar. 24, 2022

(54) METHOD FOR IMAGE PROCESSING, ELECTRONIC DEVICE AND STORAGE MEDIUM

(71) Applicant: SenseBrain Technology Limited LLC, Princeton, NJ (US)

(72) Inventors: Qian ZHANG, Princeton, NJ (US); Jun JIANG, Princeton, NJ (US); Jinwei GU, Princeton, NJ (US)

(21) Appl. No.: 17/528,435

(22) Filed: Nov. 17, 2021

(51) Int. Cl. G06T 5/00; G06T 7/11; G06K 9/62

(52) U.S. Cl. CPC G06T 5/008; G06K 9/6232; G06T 7/11

(57) ABSTRACT

A method for image processing, an electronic device, and a storage medium are provided. The method includes that: an image to be processed and respective semantic category information corresponding to each of multiple regions in the image to be processed are acquired, the respective semantic category information indicates at least one semantic category corresponding to the region; a respective category mapping parameter corresponding to each of the at least one semantic category is acquired; based on the respective semantic category information corresponding to each region and the respective category mapping parameter corresponding to each semantic category, a region mapping parameter corresponding to the region is determined; and the image to be processed is processed based on region mapping parameters corresponding to respective regions to obtain a processed image.

### TECHNICAL FIELD

The present disclosure relates to the field of data processing technologies, and in particular to a method for image processing, an electronic device, and a storage medium.

### BACKGROUND

With the development of science and technology, camera technology has become more and more mature. In daily production and life, it has become the norm to use the built-in cameras of intelligent mobile terminals (such as smart phones, tablet computers) for image capturing. Therefore, with the normalized development of image capturing, how to better meet the requirements of the users for image capturing (for example, the requirements of the users for capturing of clear images in multiple scenes including night scenes and day scenes) becomes the main development direction.

In the related art, for remedying the defect that a captured image cannot clearly present every detail in the image, the high dynamic range (HDR) technology is used for capturing the images. Compared to ordinary images, the HDR images may provide more dynamic range and image detail. The electronic device may capture multiple frames of images with different exposure times in the same scene, and compose the dark details of the over-exposure image, the middle details of the normal exposure image, and the bright details of the under-exposure image to obtain an HDR image. However, in the related HDR technology, a single image cannot be adjusted, which affects the actual experience of the users.

### SUMMARY

Embodiments of the present disclosure provide a method and apparatus for image processing, an electronic device, and a storage medium.

In a first aspect, a method for image processing is provided, which may include the following operations.

An image to be processed and respective semantic category information corresponding to each of multiple regions in the image to be processed are acquired. The respective semantic category information indicates at least one semantic category corresponding to the region.

A respective category mapping parameter corresponding to each of the at least one semantic category is acquired.

Based on the respective semantic category information corresponding to each region and the respective category mapping parameter corresponding to each semantic category, a region mapping parameter corresponding to the region is determined.

The image to be processed is processed based on region mapping parameters corresponding to respective regions to obtain a processed image.

In a second aspect, an apparatus for image processing is provided, which may include a first acquiring module, a second acquiring module, a determining module and a processing module.

The first acquiring module is configured to acquire an image to be processed respective semantic category information corresponding to each of multiple regions in the image to be processed. The respective semantic category information indicates at least one semantic category corresponding to the region.

The second acquiring module is configured to acquire a respective category mapping parameter corresponding to each of the at least one semantic category.

The determining module is configured to determine, based on the respective semantic category information corresponding to each region and the respective category mapping parameter corresponding to each semantic category, a region mapping parameter corresponding to the region.

The processing module is configured to process the image to be processed based on region mapping parameters corresponding to respective regions to obtain a processed image.

In a third aspect, an electronic device is provided, which may include a memory and a processor.

The memory is configured to store a computer program executable on the processor.

The processor is configured to execute the computer program in the memory to implement the following operations.

An image to be processed and respective semantic category information corresponding to each of multiple regions in the image to be processed are acquired. The respective semantic category information indicates at least one semantic category corresponding to the region.

A respective category mapping parameter corresponding to each of the at least one semantic category is acquired.

Based on the respective semantic category information corresponding to each region and the respective category mapping parameter corresponding to each semantic category, a region mapping parameter corresponding to the region is determined.

The image to be processed is processed based on region mapping parameters corresponding to respective regions to obtain a processed image.

In a fourth aspect, a non-transitory computer-readable storage medium is provided, which has stored thereon one or more programs that, when executed by one or more processors, cause the one or more processors to perform a method for image processing comprising the following operations.

An image to be processed and respective semantic category information corresponding to each of multiple regions in the image to be processed are acquired. The respective semantic category information indicates at least one semantic category corresponding to the region.

A respective category mapping parameter corresponding to each of the at least one semantic category is acquired.

Based on the respective semantic category information corresponding to each region and the respective category mapping parameter corresponding to each semantic category, a region mapping parameter corresponding to the region is determined.

The image to be processed is processed based on region mapping parameters corresponding to respective regions to obtain a processed image.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 is a flowchart of a method for image processing according to an embodiment of the present disclosure.

FIG. 2 is a flowchart of a method for image processing according to an embodiment of the present disclosure.

FIG. 3 is a flowchart of a method for image processing according to an embodiment of the present disclosure.

FIG. 4 is a flowchart of a method for image processing according to an embodiment of the present disclosure.

FIG. 5 is a flowchart of a method for image processing according to an embodiment of the present disclosure.

FIG. 6 is a flowchart of a method for image processing according to an embodiment of the present disclosure.

FIG. 7 is a flowchart of a method for image processing according to an embodiment of the present disclosure.

FIG. 8 is a flowchart of a method for image processing according to an embodiment of the present disclosure.

FIG. 9 is a structural diagram of an apparatus for image processing according to an embodiment of the present disclosure.

FIG. 10 is a structural diagram of the composition of an electronic device according to an embodiment of the present disclosure.

### DETAILED DESCRIPTION

The technical solutions of the present disclosure will be described in detail below by way of embodiments and with reference to the accompanying drawings. The following specific embodiments may be combined with each other, and the same or similar concepts or processes may not be described in some embodiments.

It should be noted that in the present disclosure, “first” and “second” and the like are used to distinguish the similar objects, and not necessarily used to describe a sequential or chronological order of the objects. In addition, the technical solutions described in the embodiments of the present disclosure may be arbitrarily combined without conflict.

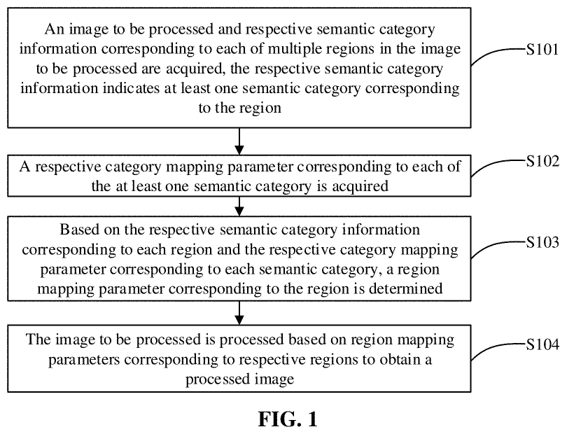

FIG. 1 is a flowchart of a method for image processing according to an embodiment of the present disclosure. As illustrated in FIG. 1, the method may include the following operations.

S101, an image to be processed and respective semantic category information corresponding to each of multiple regions in the image to be processed are acquired, the respective semantic category information indicates at least one semantic category corresponding to the region.

In some embodiments, the image to be processed may be an image that needs to be processed to improve the display effect. In order to improve the image processing efficiency and reduce the calculation pressure, the image to be processed may be an image obtained by performing compression processing on the original captured image. For example, if the original captured image has a size of 2560*2560, the original captured image may be subjected to compression processing to obtain an image to be processed having a size of 256*256.

In some embodiments, the respective semantic category information corresponding to each of multiple regions in the image to be processed can be acquired by acquiring a semantic feature image corresponding to the image to be processed. The semantic feature image includes the respective semantic category information corresponding to each of multiple regions in the image to be processed. The image to be processed includes the multiple regions. For each region of the image to be processed, the respective semantic category information is set in the semantic feature image. The respective semantic category information indicates at least one semantic category corresponding to the region.

The at least one semantic category may be preset. Different combinations of semantic categories may be set for the images to be processed in different scenes. For example, for an image to be processed in a portrait scene, a combination of semantic categories may include at least “human category and other categories”. For an image to be processed in a city scene, a combination of semantic categories may include at least “building category, sky category, human category, and ground category”. For an image to be processed in a natural scene, a combination of semantic categories may include at least “sky category, plant category, animal category, and water category”. In the embodiment, different pieces of semantic category information may be set for different scenes, so that for each of the images to be processed in different scenes, the semantic information of the image to be processed in different regions can be accurately determined, thereby providing a data basis for subsequent use of different processing strategies for different regions.

In some embodiments, for each region, the semantic category information corresponding to the region may indicate a semantic category to which the region belongs, or may indicate multiple semantic categories to which the region belongs, or may indicate multiple semantic categories to which the region belongs and a respective confidence level corresponding to each of the multiple semantic categories to which the region belongs.

S102, a respective category mapping parameter corresponding to each of the at least one semantic category is acquired.

In some embodiments, for each semantic category, the category mapping parameter corresponding to the semantic category may be used to process the region corresponding to the semantic category. The category mapping parameter may be used to determine a linear mapping relationship or a non-linear mapping relationship.

S103, based on the respective semantic category information corresponding to each region and the respective category mapping parameter corresponding to each semantic category, a region mapping parameter corresponding to the region is determined.

In some embodiments, if the semantic category information corresponding to the region indicates a semantic category to which the region belongs, the category mapping parameter corresponding to the semantic category to which the region belongs may be taken as the region mapping parameter corresponding to the region.

In some embodiments, if the semantic category information corresponding to the region indicates multiple semantic categories to which the region belongs, the category mapping parameters corresponding to respective semantic categories to which the region belongs may be fused based on the preset fusion weights, and the category mapping parameter obtained after the fusion may be taken as the region mapping parameter corresponding to the region.

In some embodiments, if the semantic category information corresponding to the region indicates multiple semantic categories to which the region belongs and a respective confidence level corresponding to each of the multiple semantic categories to which the region belongs, the category mapping parameters corresponding to respective semantic categories to which the region belongs may be fused based on the confidence levels corresponding to the respective semantic categories, and the category mapping parameter obtained after the fusion may be taken as the region mapping parameter corresponding to the region. Or, based on the confidence levels corresponding to the respective semantic categories, the category mapping parameter corresponding to the semantic category with the highest confidence level may be taken as the region mapping parameter corresponding to the region.

S104, the image to be processed is processed based on region mapping parameters corresponding to respective regions to obtain a processed image.

It should be noted that in the embodiment of the present disclosure, each of the multiple regions corresponding to the image to be processed may include at least one pixel. The pixels included in different regions may be the same or different, which is not limited in the present disclosure.

In some embodiments, each region may include a pixel. That is, for an image to be processed having a size of 256*256, the number of regions corresponding to the image to be processed is the same as the number of pixels included in the image to be processed, and both are 65536. Based on the embodiments of the present disclosure, the tone adjustment may be performed on the image to be processed based on the pixel level, thereby further improving the display effect of the processed image. Regions in following embodiments may mean pixels.

In the embodiment of the present disclosure, the image to be processed and the respective semantic category information corresponding to each region in the image to be processed are acquired, and the region mapping parameter corresponding to the region is determined based on the respective category mapping parameter corresponding to each semantic category, so that the matching between each region in the image to be processed and the respective region mapping parameter can be improved. Moreover, the obtained respective region mapping parameter corresponding to each region is associated with the at least one semantic category corresponding to the region, so that the obtained region mapping parameter better meets the image adjustment requirements for the region, thereby further improving the processing effect of the image to be processed, and that the obtained processed image can present the best image details in different regions, thereby improving the image display effect.

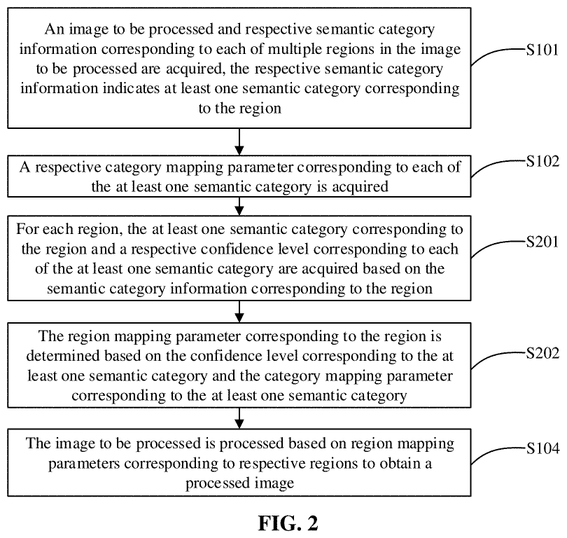

Referring to FIG. 2, FIG. 2 is a flowchart of a method for image processing according to an embodiment of the present disclosure. Based on FIG. 1, S103 in FIG. 1 may be updated to S201 and S202 which will be described with reference to FIG. 2.

S201, for each region, the at least one semantic category corresponding to the region and a respective confidence level corresponding to each of the at least one semantic category are acquired based on the semantic category information corresponding to the region.

S202, the region mapping parameter corresponding to the region is determined based on the confidence level corresponding to the at least one semantic category and the category mapping parameter corresponding to the at least one semantic category.

In some embodiments, for each region, responsive to determining that the semantic category information corresponding to the region indicates one semantic category corresponding to the region, the region mapping parameter corresponding to the region is determined based on the category mapping parameter corresponding to the one semantic category. It should be noted that in a case that the semantic category information corresponding to the region indicates one semantic category corresponding to the region, a confidence level corresponding to the one semantic category is 1.

In some embodiments, for each region, responsive to determining that the semantic category information corresponding to the region indicates multiple semantic categories corresponding to the region, a respective confidence level corresponding to each of the multiple semantic categories is acquired based on the semantic category information corresponding to the region; and the region mapping parameter corresponding to the region is determined based on confidence levels corresponding to the respective semantic categories and category mapping parameters corresponding to the respective semantic categories.

In some embodiments, the region mapping parameter corresponding to the region may be determined by performing a weighted sum of the category mapping parameter corresponding to the at least one semantic category based on the confidence level corresponding to the at least one semantic category for the region.

To facilitate understanding of the embodiment of the present disclosure, an example is given as follows. If the image to be processed includes a first region, a second region, and a third region and if the semantic category information includes a first semantic category, a second semantic category, and a third semantic category, the semantic feature image corresponding to the image to be processed may include information shown in Table 1 below.

TABLE 1

| Confidence | First semantic | Second semantic | Third semantic |
|---|---|---|---|
| level | category | category | category |
| First region | 0.5 | 0.3 | 0.2 |
| Second region | 0.1 | 0.9 | 0 |
| Third region | 0.3 | 0.1 | 0.6 |

For the first region, the semantic category information corresponding to the first region includes “(first semantic category, 0.5), (second semantic category, 0.3), (third semantic category, 0.2). Moreover, the respective category mapping parameter corresponding to each semantic category includes “the category mapping parameter corresponding to the first semantic category is M1, the category mapping parameter corresponding to the second semantic category is M2, and the category mapping parameter corresponding to the third semantic category is M3”. Thus, the region mapping parameter corresponding to the first region is 0.5*M1+0.3*M2+0.2*M3.

In some embodiments, the category mapping parameter corresponding to the semantic category with the highest confidence level may also be taken as the region mapping parameter corresponding to the region based on the confidence level corresponding to the at least one semantic category for the region.

For example, for the second region, the second semantic category corresponding to the second region has the highest confidence level, thus the region mapping parameter corresponding to the second region is set to M2.

In the embodiment of the present disclosure, the category mapping parameter corresponding to the at least one semantic category may be fused based on the at least one semantic category in the semantic category information corresponding to the region and the confidence level corresponding to the at least one semantic category, so as to obtain the region mapping parameter corresponding to the region. In this way, the obtained region mapping parameter can have a higher degree of matching with the region, which provides a data basis for subsequent processing of the region, and indirectly improves the image processing effect.

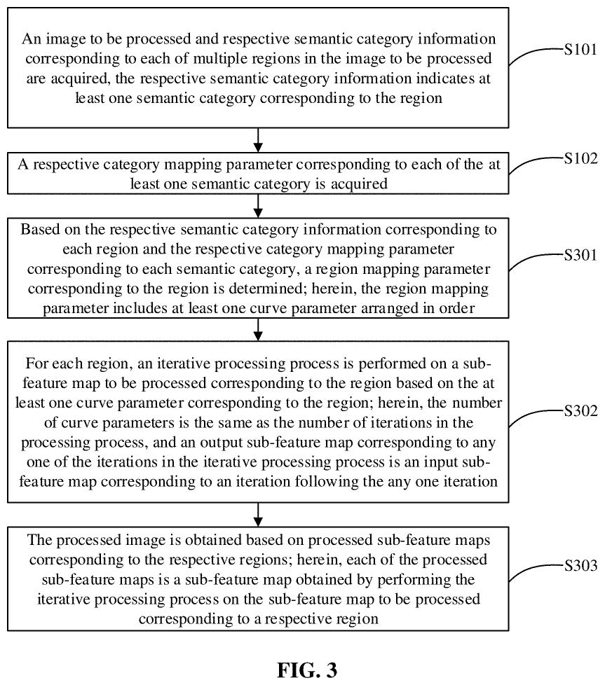

Referring to FIG. 3, FIG. 3 is a flowchart of a method for image processing according to an embodiment of the present disclosure. Based on FIG. 1, S103 in FIG. 1 may be updated to S301 which will be described with reference to FIG. 3, and S104 in FIG. 1 may be updated to S302 and S303 which will be described with reference to FIG. 3.

S301, based on the respective semantic category information corresponding to each region and the respective category mapping parameter corresponding to each semantic category, a region mapping parameter corresponding to the region is determined; herein, the region mapping parameter includes at least one curve parameter arranged in order.

In some embodiments, the region mapping parameter may include the at least one curve parameter arranged in order. Herein, each of the at least one curve parameter is used to determine a respective iteration in S302. Moreover, the sequence number of each of the curve parameters arranged in order is the same as the sequence number of a respective one of the iterations performed in order in the iterative processing process. For example, the region mapping parameter may include “M11, M12, M13, . . . , MIN” arranged in order. M11 is used to determine the first iteration, M12 is used to determine the second iteration, and M13 is used to determine the third iteration, and so on.

It should be noted that in the embodiment, each category mapping parameter for determining the region mapping parameter also includes at least one curve parameter arranged in order. For example, the region mapping parameter may include “M11, M12, M13, . . . , MIN”, each category mapping parameter for determining the region mapping parameter may also include N curve parameters arranged in order, and the nth curve parameter in the region mapping parameter is associated with the nth curve parameter in the category mapping parameter.

S302, for each region, an iterative processing process is performed on a sub-feature map to be processed corresponding to the region based on the at least one curve parameter corresponding to the region; herein, the number of curve parameters is the same as the number of iterations in the iterative processing process, and an output sub-feature map corresponding to any one of the iterations in the iterative processing process is an input sub-feature map corresponding to an iteration following the any one iteration.

In some embodiments, for any region, during performing the iterative processing process on the any region, upon obtaining an output sub-feature map corresponding to any one of the iterations in the iterative processing process, the output sub-feature map corresponding to the any one iteration may be taken as an input sub-feature map corresponding to an iteration following the any one iteration. For example, the input data of the first iteration is the sub-feature map to be processed corresponding to the region so as to obtain the first iteration output data corresponding to the region, the input data of the second iteration is the first iteration output data so as to obtain the second iteration output data corresponding to the region, and so on, the data output from the last iteration is taken as the processed sub-feature map corresponding to the region.

S303, the processed image is obtained based on processed sub-feature maps corresponding to the respective regions; herein, each of the processed sub-feature maps is a sub-feature map obtained by performing the iterative processing process on the sub-feature map to be processed corresponding to a respective region.

In some embodiments, for a sub-feature map to be processed corresponding to any region in the image to be processed, the iterative processing process is performed on the sub-feature map to be processed is performed to obtain a processed sub-feature map corresponding to the region. Then, the processed image is obtained based on the processed sub-feature maps corresponding to the respective regions.

In the embodiment of the present disclosure, use of the iterative processing process including multiple iterations may provide more diverse image processing strategies, so as to enhance the application scope of the embodiment of the present disclosure.

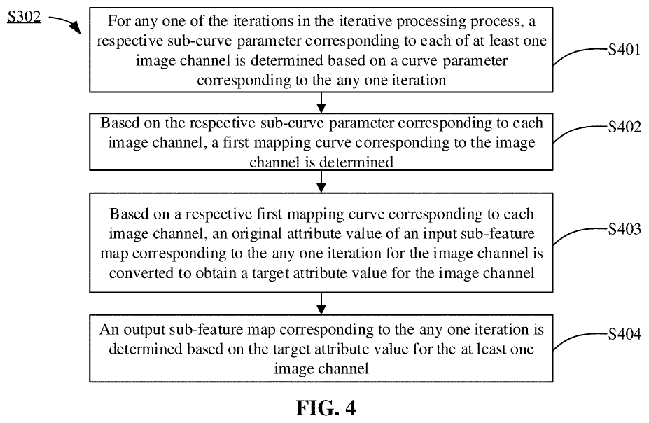

Referring to FIG. 4, FIG. 4 is a flowchart of a method for image processing according to an embodiment of the present disclosure. Based on FIG. 3, S302 in FIG. 3 may include S401 to S404 which will be described with reference FIG. 4.

S401, for any one of the iterations in the iterative processing process, a respective sub-curve parameter corresponding to each of at least one image channel is determined based on a curve parameter corresponding to the any one iteration.

In some embodiments, the image to be processed corresponds to the at least one image channel. Accordingly, the curve parameter includes the respective sub-curve parameter corresponding to each of the at least one image channel. For example, the image to be processed may correspond to three image channels including R channel, G channel and B channel. Any one of the at least one curve parameter may include a sub-curve parameter corresponding to the R channel, a sub-curve parameter corresponding to the G channel, and a sub-curve parameter corresponding to the B channel.

In some embodiments, in the any one iteration, the curve parameter corresponding to the any one iteration is acquired, and the curve parameter includes the respective sub-curve parameter corresponding to each image channel in the any one iteration. Herein, based on the sequence number of the any one iteration, the curve parameter of which the sequence number is the same as the sequence number of the any one iteration is acquired from the region mapping parameter.

S402, based on the respective sub-curve parameter corresponding to each image channel, a first mapping curve corresponding to the image channel is determined.

In some embodiments, the first mapping curve may be represented by formula (1) below.

$$f ( x ) = \frac{L}{1 + {e}^{- k ( x - {x}_{0} )}} . \qquad Formula ( 1 )$$

Herein, L is the maximum value of the first mapping curve, x₀ represents the position of the center point of the first mapping curve (i.e., s-shaped curve), and k is the sub-curve parameter for determining the first mapping curve. In some embodiments, both L and x₀ are preset empirical parameters.

For example, for the any one iteration, if the image to be processed includes the three image channels, that is, the R channel, the G channel and the B channel, the curve parameter corresponding to the any one iteration for the region may include the sub-curve parameter Mr corresponding to the R channel, the sub-curve parameter Mg corresponding to the G channel and the sub-curve parameter Mb corresponding to the B channel. Accordingly, through the operation S402, the first mapping curve corresponding to the R channel, the first mapping curve corresponding to the G channel and the first mapping curve corresponding to the B channel may be obtained. Herein, the first mapping curve corresponding to the R channel may be represented by the formula (2), the first mapping curve corresponding to the G channel may be represented by the formula (3), and the first mapping curve corresponding to the B channel may be represented by the formula (4).

$$\begin{matrix}f ( x ) = \frac{L}{1 + {e}^{- M r ( x - {x}_{0} )}} . & Formula ( 2 ) \\ f ( x ) = \frac{L}{1 + {e}^{- M g ( x - {x}_{0} )}} . & Formula ( 3 ) \\ f ( x ) = \frac{L}{1 + {e}^{- M b ( x - {x}_{0} )}} . & Formula ( 4 )\end{matrix}$$

S403, based on a respective first mapping curve corresponding to each image channel, an original attribute value of an input sub-feature map corresponding to the any one iteration for the image channel is converted to obtain a target attribute value for the image channel.

In some embodiments, the input sub-feature map corresponding to the any one iteration may include at least one input pixel. For each input pixel, a respective original attribute value of the input pixel for each image channel may be acquired, and the processing of the input sub-feature map in the any one iteration may be completed based on the first mapping curve corresponding to the at least one image channel, that is, a respective target attribute value of the at least one input pixel for each image channel may be obtained.

For example, the input sub-feature map corresponding to the any one iteration may include N input pixels, and the image channels may include the R channel, the G channel and the B channel. For each input pixel Pn, it is determined that the original attribute values of the input pixel Pn for the respective image channels include (Pnr, Png, Pnb). Based on the first mapping curves represented by the formulas (2)-(4), it can be obtained that the target attribute values of the input pixel Pn for the respective image channels include

$$( \frac{L}{1 + {e}^{- M r ( P n r - {x}_{0} )}} \frac{L}{1 + {e}^{- M g ( P n g - {x}_{0} )}} , \frac{L}{1 + {e}^{- M b ( P n b - {x}_{0} )}} ) .$$

Therefore, the target attribute values of all the input pixels of the input sub-feature map for the respective image channels can be obtained.

S404, an output sub-feature map corresponding to the any one iteration is determined based on the target attribute value for the at least one image channel.

In some embodiments, the output sub-feature map corresponding to the any one iteration can be determined by obtaining the respective target attribute value of the at least one input pixel of the input sub-feature map for each image channel.

In the embodiment of the present disclosure, for different image channels in the image to be processed, the curve parameter corresponding to the region further includes the respective sub-curve parameter corresponding to each image channel, and in each iteration, a different first mapping curve is generated for each image channel and the respective original attribute value corresponding to each image channel is converted to obtain the output sub-feature map corresponding to the iteration, so that the accuracy of the image processing can be improved, and the overall image processing effect is guaranteed.

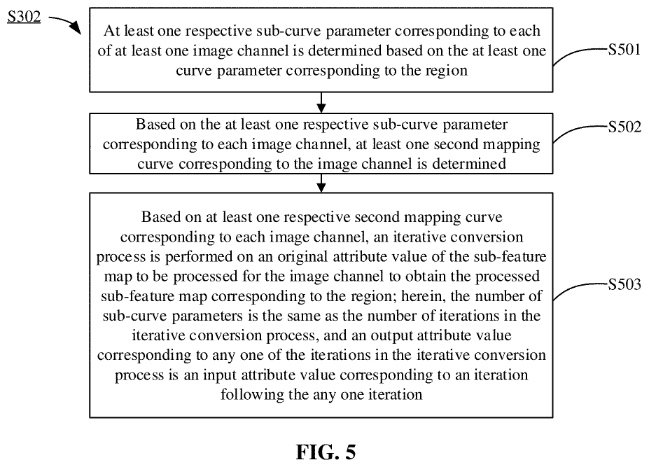

Referring to FIG. 5, FIG. 5 is a flowchart of a method for image processing according to an embodiment of the present disclosure. Based on FIG. 3, S302 in FIG. 3 may include S501 to S503 which will be described with reference to FIG. 5.

S501, at least one respective sub-curve parameter corresponding to each of at least one image channel is determined based on the at least one curve parameter corresponding to the region.

In some embodiments, the image to be processed corresponds to the at least one image channel. Accordingly, the curve parameter includes a respective sub-curve parameter corresponding to each image channel. For example, if the image to be processed may correspond to three image channels including R channel, G channel and B channel, any one of the at least one curve parameter may include the sub-curve parameter corresponding to the R channel, the sub-curve parameter corresponding to the G channel, and the sub-curve parameter corresponding to the B channel.

In some embodiments, since any one of the at least one curve parameter includes a respective sub-curve parameter corresponding to each image channel, before performing the iterative processing process, the at least one curve parameter corresponding to the region is divided based on each image channel to obtain at least one sub-curve parameter corresponding to the image channel, and then the respective iterative processing process corresponding to each image channel can be completed.

For example, the region corresponds to three curve parameters (M1, M2 and M3) and the image channels include three channels (R channel, G channel and B channel). Based on the operation S501, it can be obtained at least one sub-curve parameter corresponding to the R channel which includes (M1r, M2r and M3r), at least one sub-curve parameter corresponding to the channel G which includes (M1g, M2g and M3g), and at least one sub-curve parameter corresponding to the channel B which includes (M1b, M2b and M3b).

S502, based on the at least one respective sub-curve parameter corresponding to each image channel, at least one second mapping curve corresponding to the image channel is determined.

In some embodiments, for each image channel, taking the R channel as an example, at least one second mapping curve corresponding to the R channel can be obtained based on the at least one sub-curve parameter (M1r, M2r, and M3r) corresponding to the R channel. The at least one second mapping curve is represented by the formulas (5), (6) and (7) below.

$$\begin{matrix}f ( x ) = \frac{L}{1 + {e}^{- M 1 r ( x - {x}_{0} )}} . & Formula ( 5 ) \\ f ( x ) = \frac{L}{1 + {e}^{- M 2 r ( x - {x}_{0} )}} . & Formula ( 6 ) \\ f ( x ) = \frac{L}{1 + {e}^{- M 3 r ( x - {x}_{0} )}} . & Formula ( 7 )\end{matrix}$$

In operation S503, based on at least one respective second mapping curve corresponding to each image channel, an iterative conversion process is performed on an original attribute value of the sub-feature map to be processed for the image channel to obtain the processed sub-feature map corresponding to the region; herein, the number of sub-curve parameters is the same as the number of iterations in the iterative conversion process, and an output attribute value corresponding to any one of the iterations in the iterative conversion process is an input attribute value corresponding to an iteration following the any one iteration.

In some embodiments, the sub-feature map to be processed may include at least one pixel to be processed. For each pixel to be processed, a respective original attribute value of the pixel to be processed for each image channel may be acquired. For each image channel, taking the R channel as an example, the original attribute value of the sub-feature map to be processed for the R channel is subjected to the iterative conversion process based on at least one second mapping curve corresponding to the R channel. Herein, based on the examples of the above formulas (5)-(7), the iterative conversion process may include the following contents. The original attribute value XO of the sub-feature map to be processed for the R channel is acquired. The first iterative conversion is performed through the formula (5) to obtain the conversion result

$$X 1 \frac{L}{- 1 + {e}^{- M 1 r ( X 0 - {x}_{0} )}} ,$$

the second iterative conversion is performed through the formula (6) to obtain the conversion result

$$X 2 \frac{L}{- 1 + {e}^{- M 2 r ( X 1 - {x}_{0} )}} ,$$

and the third iterative conversion is performed through the formula (7) to obtain the conversion result

$$X 3 = \frac{L}{1 + {e}^{- M 3 r ( X 2 - {x}_{0} )}} .$$

X3 is taken as the target attribute value obtained by performing the iterative conversion process on the original attribute value of the sub-feature map to be processed for the R channel. By analogy, the target attribute values obtained by performing the iterative conversion process on the original attribute values for all the image channels can be obtained, and then the processed sub-feature map corresponding to the region can be obtained.

In the embodiment of the present disclosure, for different image channels in the image to be processed, at least one respective sub-curve parameter and at least one respective second mapping curve corresponding to each image channel are acquired, and then a respective original attribute value of the sub-feature map to be processed for each image channel is subjected to the iterative conversion process, so that not only the accuracy of image processing but also the overall image processing efficiency can be improved.

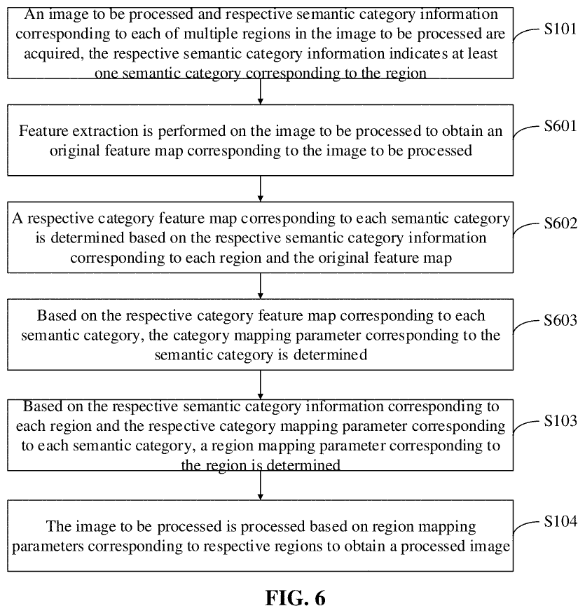

Referring to FIG. 6, FIG. 6 is a flowchart of a method for image processing according to an embodiment of the present disclosure. Based on FIG. 1, S102 in FIG. 1 may be updated to S601 to S603 which will be described with reference to FIG. 6.

S601, feature extraction is performed on the image to be processed to obtain an original feature map corresponding to the image to be processed.

In some embodiments, the features of the image to be processed may be extracted through a trained image processing model to obtain an original feature map corresponding to the image to be processed. Herein, the feature extraction process may be implemented by multiple convolution layers sequentially connected.

In some embodiments, if the image to be processed includes H image channels, an original feature map with K*H channels can be obtained by performing the feature extraction of the image to be processed by the image processing model, where K is the number of the curve parameters, that is, the number of iterations in the iterative processing process.

For example, the image to be processed has a size of 256*256*3. If the number of curve parameters is eight, or eight iterations are required to be performed, the original feature map with the size of 256*256*24 can be obtained by performing the feature extraction of the image to be processed by the image processing model.

S602, a respective category feature map corresponding to each semantic category is determined based on the respective semantic category information corresponding to each region and the original feature map.

Herein, the operation that the respective category feature map corresponding to each semantic category is determined based on the respective semantic category information corresponding to each region and the original feature map may be implemented in the following manner.

For each region, the at least one semantic category corresponding to the region and a respective confidence level corresponding to each of the at least one semantic category are acquired based on the semantic category information corresponding to the region; and based on the respective confidence level corresponding to each semantic category and an original sub-feature map in the region corresponding to the original feature map, a category sub-feature map corresponding to the semantic category is determined.

For each semantic category, the category feature map corresponding to the semantic category is determined based on category sub-feature maps corresponding to the semantic category for the respective regions.

In some embodiments, for example, the region includes only one pixel, and the original feature map includes I*J pixels, where each pixel corresponds to a respective original feature value Fᵢⱼ. During determining the category feature map corresponding to any one of the at least one semantic category, based on the respective original feature value Fᵢⱼ corresponding to each pixel and the confidence level Pᵢⱼ corresponding to the semantic category for the pixel, the category feature value Fᵢⱼ*Pᵢⱼ (corresponding to the category sub-feature map in the above operation) corresponding to the pixel may be determined, and then the category feature map corresponding to the semantic category may be obtained. Similarly, the category feature maps corresponding to all the semantic categories can be obtained.

S603, based on the respective category feature map corresponding to each semantic category, the category mapping parameter corresponding to the semantic category is determined.

In some embodiments, the respective category feature map corresponding to each semantic category may be converted through the trained image processing model to obtain the category mapping parameter corresponding to the semantic category. Herein, a respective fully connected layer may be set for each semantic category. For any semantic category, the fully connected layer corresponding to the any semantic category may convert the category feature map corresponding to the any semantic category into the category mapping parameter corresponding to the semantic category.

For example, the category feature map corresponding to the any semantic category has a size of 256*256*24. The fully connected layer corresponding to the any semantic category can convert the category feature map into one-dimensional feature (O1, O2, . . . , O24) of 1*1*24. Moreover, the number of image channels in the image to be processed is three, so it can be obtained that the category mapping parameter corresponding to the any semantic category may include eight curve parameters (M1, M2, . . . , M8) arranged in order, where M1 includes (O1, O2, and O3), M2 includes (O4, O5, and O6), and so on.

In the embodiment of the present disclosure, the respective category feature map corresponding to each semantic category can be generated in real time for different images to be processed, so that the image processing effect and the application range of the above method for image processing can be further improved.

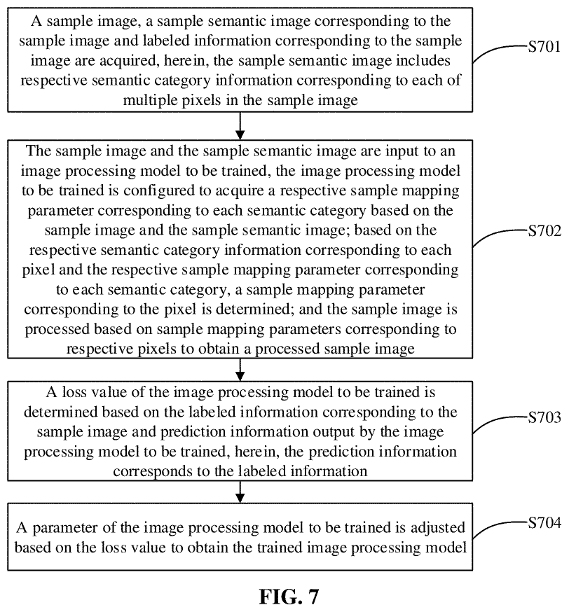

Referring to FIG. 7, FIG. 7 is a flowchart of a training process of the image processing model according to an embodiment of the present disclosure, which will be described with reference to the operations illustrated in FIG. 7.

S701, a sample image, a sample semantic image corresponding to the sample image and labeled information corresponding to the sample image are acquired, herein, the sample semantic image includes respective semantic category information corresponding to each of multiple pixels in the sample image.

S702, the sample image and the sample semantic image are input to an image processing model to be trained, the image processing model to be trained is configured to acquire a respective sample mapping parameter corresponding to each semantic category based on the sample image and the sample semantic image; based on the respective semantic category information corresponding to each pixel and the respective sample mapping parameter corresponding to each semantic category, a sample mapping parameter corresponding to the pixel is determined; and the sample image is processed based on sample mapping parameters corresponding to respective pixels to obtain a processed sample image.

S703, a loss value of the image processing model to be trained is determined based on the labeled information corresponding to the sample image and prediction information output by the image processing model to be trained, herein, the prediction information corresponds to the labeled information.

In some embodiments, the labeled information may include at least one of a respective labeled mapping parameter corresponding to each semantic category, or, a standard processed image corresponding to the sample image. It should be noted that the prediction information corresponds to the labeled information. That is, if the labeled information includes only the respective labeled mapping parameter corresponding to each semantic category, the prediction information output by the image processing model to be trained includes the respective sample mapping parameter corresponding to each semantic category. If the labeled information includes only the standard processed image, the prediction information output by the image processing model to be trained includes the processed sample image. If the labeled information includes respective labeled mapping parameter corresponding to each semantic category and the standard processed image, the prediction information output by the image processing model to be trained includes the respective sample mapping parameter corresponding to each semantic category and the processed sample image.

It should be noted that the standard processed image is preset. Compared with the sample image, a pixel value of each region in the standard processed image had been adjusted to a target pixel value that meets the display requirements. The image processing model trained based on the standard processed image may process an input image into an image that meets the display requirements. For example, if the tone of the region corresponding to the building category in the sample image is warm tone and the tone of the region corresponding to the building category in the standard processed image corresponding to the sample image is cold tone, the image processing model trained based on the sample image and the standard processed image may adjust, to be lower, the color temperature of the region corresponding to the building category in the image to be processed.

S704, a parameter of the image processing model to be trained is adjusted based on the loss value to obtain the trained image processing model.

In some embodiments, the loss value of the image processing model to be trained includes a first loss value if the labeled information includes the respective labeled mapping parameter corresponding to each semantic category. The first loss value is acquired in the following manner. The first loss value is determined based on the respective labeled mapping parameter corresponding to each semantic category for the sample image and based on the respective sample mapping parameter corresponding to each semantic category which is acquired by the image processing model to be trained.

Accordingly, the operation that the parameter of the image processing model to be trained is adjusted based on the loss value to obtain the trained image processing model may include the following operation. The parameter of the image processing model to be trained is adjusted based on at least the first loss value to obtain the trained image processing model.

In some embodiments, the loss value of the image processing model to be trained includes a second loss value if the labeled information includes the standard processed image corresponding to the sample image. The second loss value is acquired in the following manner. The second loss value is determined based on the standard processing image corresponding to the sample image and based on the processed sample image output by the image processing model to be trained.

Accordingly, the operation that the parameter of the image processing model to be trained is adjusted based on the loss value to obtain the trained image processing model may include the following operation. The parameter of the image processing model to be trained is adjusted based on at least the second loss value to obtain the trained image processing model.

In some embodiments, the loss value of the image processing model to be trained includes a first loss value and a second loss value if the labeled information includes the respective labeled mapping parameter corresponding to each semantic category and the standard processing image corresponding to the sample image.

Accordingly, the operation that the parameter of the image processing model to be trained is adjusted based on the loss value to obtain the trained image processing model may include the following operation. The parameter of the image processing model to be trained is adjusted based on the first loss value and the second loss value to obtain the trained image processing model.

Through the image processing model obtained based on the foregoing embodiments, different processing strategies can be adopted for different the images to be processed, thereby improving the pertinence of image processing. Moreover, the respective region mapping parameter corresponding to each region is determined based on the category mapping parameter corresponding to at least one semantic category for the region, so that the degree of matching between each region in the image to be processed and the region mapping parameter corresponding to the region can be improved. Further, the obtained processed image can present the best image details in different regions, thereby improving the display effect of the entire image.

In the following, an exemplary application of the embodiments of the present disclosure in an actual application scenario will be described.

High dynamic range (HDR) images capture the real-world light transport in linear intensities. The common displays, however, usually cannot accommodate such a large range of pixel intensities and colors. Therefore, the captured raw data go through several in-camera image signal processing modules that decode the image signal from color filter arrays, de-noise the image, convert to intended color space, compress the dynamic range, and conduct final adjustments and correction. An output image suitable for viewing with a limited range is desired.

Dynamic range compression, or tone mapping, is vital in the image signal processing pipeline. The compressed output image should match the human vision perception, which requires the algorithm to be robust to dramatic lighting changes in the scene. It is, however, difficult to design such a module with hand-engineered features. Making changes in the tone mapping module also has influences on other modules. Tuning several modules at the same time is not efficient and may introduce artifacts due to interferences among modules.

Therefore, the embodiments of the present disclosure use the mechanism of attention to provide an optimized HDR tone mapping module that is robust to various lighting conditions in different scenes. The output image has a reasonable local contrast and enhancement to salient regions where people usually pay more attention to, especially for backlit images or night-time scenes. The embodiments of the present disclosure also use an image signal processing pipeline which includes the tone mapping module to process the sensor raw data and output a well-touched image with natural colors.

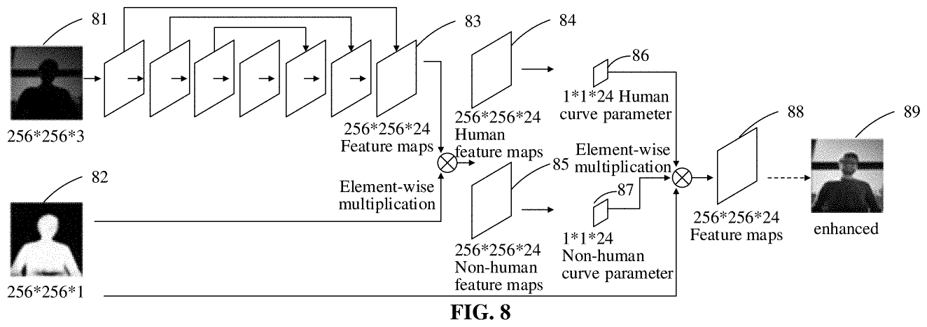

Referring to FIG. 8, FIG. 8 is an architecture diagram of the tone mapping module. The tone mapping module (corresponding to the image processing model in the embodiments described above) may generate an enhanced image (corresponding to the processed image in the embodiments described above) corresponding to a linear input image (corresponding to the image to be processed in the embodiments described above) based on the linear input image and a float matte image (or called “mask”, corresponding to the semantic feature image in the embodiments described above).

For ease of understanding, the embodiments of the present disclosure will be described by taking two semantic categories (i.e., a human category and a non-human category) as an example. The present disclosure may also perform enhancement processing on linear input images with three or more semantic categories.

In the first step, a linear input image 81 with a size of 256*256*3 may be input to a first feature extraction network in the tone mapping module to obtain an original feature map 83 with a size of 256*256*24.

In the second step, the element-wise multiplication is performed on the original feature map 83 and a float matte image 82 with a size of 256*256*1 to obtain a category feature map 84 corresponding to the human category and a category feature map 85 corresponding to the non-human category. Herein, in the embodiment, only two semantic categories are involved, so the confidence levels corresponding to the two different semantic categories can be determined based on only “1 (one)” feature value. For example, this feature value may be set to be any value (e.g., R) in a range of 0 to 1, which is used for characterizing the confidence level corresponding to the human category, thus the confidence level corresponding to the non-human category is (1-R).

In the third step, the tone mapping model may perform feature conversion on the category feature map 84 corresponding to the human category and the category feature map 85 corresponding to the non-human category, respectively, to obtain a category mapping parameter 86 corresponding to the human category and a category mapping parameter 87 corresponding to the non-human category. Herein, a respective fully connected layer may be set for each semantic category. For example, the fully connected layer corresponding to the human category may be used to convert the category feature map 84 with the size of 256*256*24 corresponding to the human category into the category mapping parameter 86 with the size of 1*1*24 corresponding to the human category. The fully connected layer corresponding to the non-human category may be used to convert the category feature map 85 with the size of 256*256*24 corresponding to the non-human category into the category mapping parameter 87 with the size of 1*1*24 corresponding to the non-human category.

In the fourth step, a mapping parameter feature map 88 with the size of 256*256*24 is determined based on the float matte image 82 with the size of 256*256*1, the category mapping parameter 86 with the size of 1*1*24 corresponding to the human category, and the category mapping parameter 87 with the size of 1*1*24 corresponding to the non-human category. The mapping parameter feature map 88 includes the at least one respective curve parameter corresponding to each pixel (region) in the linear input image 81.

In the fifth step, iterative processing process is performed on the linear input image 81 based on the obtained mapping parameter feature map 88 to obtain the processed enhanced image 89. The number of iterations in the iterative processing process is 24/3=8.

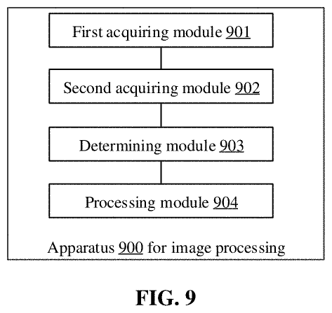

FIG. 9 is a structural diagram of an apparatus for image processing according to an embodiment of the present disclosure. As illustrated in FIG. 9, the apparatus 900 for image processing includes a first acquiring module 901, a second acquiring module 902, a determining module 903 and a processing module 904.

The first acquiring module 901 is configured to acquire an image to be processed and respective semantic category information corresponding to each of multiple regions in the image to be processed, the respective semantic category information indicates at least one semantic category corresponding to the region.

The second acquiring module 902 is configured to acquire a respective category mapping parameter corresponding to each of the at least one semantic category.

The determining module 903 is configured to determine, based on the respective semantic category information corresponding to each region and the respective category mapping parameter corresponding to each semantic category, a region mapping parameter corresponding to the region.

The processing module 904 is configured to process the image to be processed based on region mapping parameters corresponding to respective regions to obtain a processed image.

In some embodiments, the determining module 903 is further configured to: for each region, responsive to determining that the semantic category information corresponding to the region indicates one semantic category corresponding to the region, determine, based on the category mapping parameter corresponding to the one semantic category, the region mapping parameter corresponding to the region.

In some embodiments, the determining module 903 is further configured to: for each region, responsive to determining that the semantic category information corresponding to the region indicates a plurality of semantic categories corresponding to the region, acquire, based on the semantic category information corresponding to the region, a respective confidence level corresponding to each of the plurality of semantic categories; and determine, based on confidence levels corresponding to the respective semantic categories and category mapping parameters corresponding to the respective semantic categories, the region mapping parameter corresponding to the region.

In some embodiments, the region mapping parameter includes at least one curve parameter arranged in order. The processing module 904 is further configured to: for each region, perform, based on the at least one curve parameter corresponding to the region, an iterative processing process on a sub-feature map to be processed corresponding to the region, herein, the number of curve parameters is the same as the number of iterations in the iterative processing process, and an output sub-feature map corresponding to any one of the iterations in the iterative processing process is an input sub-feature map corresponding to an iteration following the any one iteration; and obtain the processed image based on processed sub-feature maps corresponding to the respective regions, herein, each of the processed sub-feature maps is a sub-image obtained by performing the iterative processing process on the sub-feature map to be processed corresponding to a respective region.

In some embodiments, the image to be processed corresponds to at least one image channel. The processing module 904 is further configured to: for any one of the iterations in the iterative processing process, determine, based on a curve parameter corresponding to the any one iteration, a respective sub-curve parameter corresponding to each of the at least one image channel; determine, based on the respective sub-curve parameter corresponding to each image channel, a first mapping curve corresponding to the image channel; convert, based on a respective first mapping curve corresponding to each image channel, an original attribute value of an input sub-feature map corresponding to the any one iteration for the image channel to obtain a target attribute value for the image channel; and determine, based on the target attribute value for the at least one image channel, an output sub-feature map corresponding to the any one iteration.

In some embodiments, the image to be processed corresponds to at least one image channel. The processing module 904 is further configured to: determine, based on the at least one curve parameter corresponding to the region, at least one respective sub-curve parameter corresponding to each of the at least one image channel; determine, based on the at least one respective sub-curve parameter corresponding to each image channel, at least one second mapping curve corresponding to the image channel; and perform, based on at least one respective second mapping curve corresponding to each image channel, an iterative conversion process on an original attribute value of the sub-feature map to be processed for the image channel to obtain the processed sub-feature map corresponding to the region; herein, the number of sub-curve parameters is the same as the number of iterations in the iterative conversion process, and an output attribute value corresponding to any one of the iterations in the iterative conversion process is an input attribute value corresponding to an iteration following the any one iteration.

In some embodiments, the second acquiring module 902 is further configured to: perform feature extraction on the image to be processed to obtain an original feature map corresponding to the image to be processed; determine, based on the respective semantic category information corresponding to each region and the original feature map, a respective category feature map corresponding to each semantic category; and determine, based on the respective category feature map corresponding to each semantic category, the category mapping parameter corresponding to the semantic category.

In some embodiments, the second acquiring module 902 is further configured to: for each region, acquire, based on the semantic category information corresponding to the region, the at least one semantic category corresponding to the region and a respective confidence level corresponding to each of the at least one semantic category; and determine, based on the respective confidence level corresponding to each semantic category and an original sub-feature map in the region corresponding to the original feature map, a category sub-feature map corresponding to the semantic category; and for each semantic category, determine, based on category sub-feature maps corresponding to the semantic category for the respective regions, the category feature map corresponding to the semantic category.

In some embodiments, each of the multiple regions in the image to be processed includes at least one pixel.

In some embodiments, the apparatus 900 for image processing further includes a training module which is configured to: acquire a sample image, a sample semantic image corresponding to the sample image, and labeled information corresponding to the sample image, herein, the sample semantic image includes respective semantic category information corresponding to each of multiple pixels in the sample image; input the sample image and the sample semantic image to an image processing model to be trained, herein, the image processing model to be trained is configured to acquire a respective sample mapping parameter corresponding to each semantic category based on the sample image and the sample semantic image; determine, based on the respective semantic category information corresponding to each pixel and the respective sample mapping parameter corresponding to each semantic category, a sample mapping parameter corresponding to the pixel; process the sample image based on sample mapping parameters corresponding to respective pixels to obtain a processed sample image; determine, based on the labeled information corresponding to the sample image and prediction information output by the image processing model to be trained, a loss value of the image processing model to be trained, herein, the prediction information corresponds to the labeled information; and adjust, based on the loss value, a parameter of the image processing model to be trained to obtain a trained image processing model.

In some embodiments, the labeled information includes at least one of: a respective labeled mapping parameter corresponding to each semantic category, or, a standard processed image corresponding to the sample image.

In some embodiments, the loss value of the image processing model to be trained includes a first loss value if the labeled information includes the respective labeled mapping parameter corresponding to each semantic category. The training module is further configured to: determine the first loss value based on the respective labeled mapping parameter corresponding to each semantic category for the sample image and based on the respective sample mapping parameter corresponding to each semantic category which is acquired by the image processing model to be trained; and adjust, based on at least the first loss value, the parameter of the image processing model to be trained to obtain the trained image processing model.

In some embodiments, the loss value of the image processing model to be trained includes a second loss value if the labeled information includes the standard processed image corresponding to the sample image. The training module is further configured to: determine the second loss value based on the standard processed image corresponding to the sample image and based on the processed sample image output by the image processing model to be trained; and adjust, based on at least the second loss value, the parameter of the image processing model to be trained to obtain the trained image processing model.

The descriptions of the above apparatus embodiments are similar to the descriptions of the above method embodiments, and have similar advantageous effects as the method embodiments. The technical details not disclosed in the apparatus embodiments of the present disclosure may be understood with reference to the descriptions of the method embodiments of the present disclosure.

It should be noted that in the embodiments of the present disclosure, if the aforementioned methods for image processing are implemented in the form of a software functional module and is sold or used as an independent product, it may also be stored in a computer-readable storage medium. Based on such an understanding, the technical solutions of the embodiments of the present disclosure, or portions contributing to the related art, may be embodied in the form of a software product stored in a storage medium including several instructions for causing a device to perform all or portions of the method embodiments of the present disclosure. The foregoing storage medium may include a universal serial bus (USB) flash drive, a removable hard disk, a read only memory (ROM), a magnetic disk, an optical disk, or any other medium that can store program codes. Thus, the embodiments of the present disclosure are not limited to any specific combination of hardware and software.

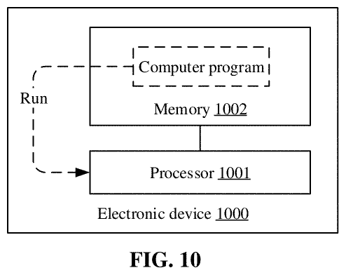

FIG. 10 is a structural diagram of the composition of an electronic device according to an embodiment of the present disclosure. As illustrated in FIG. 10, the electronic device 1000 includes a processor 1001 and a memory 1002. The memory 1002 is configured to store a computer program executable on the processor 1001, and the processor 1001 is configured to execute the computer program to implement the method of any one of the aforementioned embodiments. The electronic device may be for example a mobile device, a computer, a tablet device or the like.

The memory 1002 is configured to store computer programs executable on the processor. The memory 1002 may be configured to store instructions and applications executable by the processor 1001, or cache the data that has been processed or the data to be processed (e.g., image data, audio data, voice communication data, and video communication data) by the processor 1001 and the modules in the electronic device 1000. The memory may be implemented by a flash memory or a random access memory (RAM).

The processor 1001 is configured to execute the computer program to implement any one of the methods in aforementioned embodiments. The processor 1001 generally controls the overall operation of the electronic device 1000.

The embodiments of the present disclosure provide a computer storage medium having stored thereon one or more programs that, when executed by one or more processors, cause the one or more processors to implement any one of the methods in aforementioned embodiments. In some embodiments, the computer storage medium may be a non-transitory computer-readable storage medium.

It should be noted that the descriptions of the above storage medium and apparatus embodiments are similar to the descriptions of the above method embodiments and have similar advantageous effects as the method embodiments. The technical details not disclosed in the storage medium and the device embodiments of the present disclosure may be understood with reference to the descriptions of the method embodiments of the present disclosure.

In some embodiments, the processor may be at least one of: an application specific integrated circuit (ASIC), a digital signal processor (DSP), a Digital Signal Processing Device (DSPD), a programmable logic device (PLD), a field programmable gate array (FPGA), a central processing unit (CPU), a controller, a microcontroller, or a microprocessor. It may be understood that the electronic devices implementing the above-described processor functions may be other devices, and the embodiments of the present disclosure are not specifically limited.

In some embodiments, the computer storage medium/memory may be a read only memory (ROM), a programmable read only memory (PROM), an erasable programmable read only memory (EPROM), an electrically erasable programmable read only memory (EEPROM), a Ferromagnetic random access memory (FRAM), a flash memory, a magnetic surface memory, an optical disc, or an optical disc read only memory (CD-ROM) or the like. It may also be various terminals including one or any combination of the above memories, such as a mobile phone, a computer, a tablet device, a personal digital assistant, or the like.

It should be understood that “one embodiment”, “an embodiment”, “the embodiment of the present disclosure”, “the aforementioned embodiments” or “some embodiments” mentioned in the present disclosure may mean that the features, structures or characteristics of the objects related to the embodiment(s) are included into at least one embodiment of the present disclosure. Therefore, “one embodiment”, “an embodiment”, “the embodiment of the present disclosure”, “the aforementioned embodiments” or “some embodiments” mentioned in the present disclosure may not necessarily involve the same embodiments. In addition, the features, structures or characteristics of the objects may be combined in any suitable manner in one or more embodiments. It should be understood that in the various embodiments of the present disclosure, the sizes of the sequence number of the foregoing operations does not mean the execution order of the operations. The execution order of the operations should be determined based on the functions and internal logic of the operations, and should not constitute any limitation on the implementation of the embodiments of the present disclosure.

Unless otherwise specified, the electronic device executes any one of the operations in the embodiments of the present disclosure, which may refer to that the processor of the electronic device executes the any one operation. Unless otherwise specified, the embodiments of the present disclosure do not limit the order in which the electronic device executes the operations. In addition, the methods used to process the data in different embodiments may be the same method or different methods. It should also be noted that the any one operation in the embodiments of the present disclosure may be independently executed by the electronic device. That is, the electronic device may execute the any one operation in the embodiments of the present disclosure without relying on the execution of other operations.

In the embodiments of the present disclosure, it should be understood that the disclosed apparatuses, devices and methods may be implemented in other ways. The apparatus or device embodiments described above are merely illustrative. For example, the division of the units is merely a logical function division, and other division manners may be adopted during the actual implementation. For example, multiple units or components may be combined, or may be integrated into another system, or some characteristics may be ignored or not performed. In addition, In addition, coupling or direct coupling or communication connection between each displayed or discussed component may be indirect coupling or communication connection, implemented through some interfaces, of devices or the units, and may be electrical, mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions in the embodiments according to practical requirements.

In addition, each functional unit in each embodiment of the disclosure may be integrated into a processing unit, each unit may also physically exist independently, and two or more than two units may also be integrated into a unit. The integrated unit may be implemented in the form of hardware, or may be implemented in the form of hardware and software functional units.

The methods disclosed in the several method embodiments provided by the present disclosure may be arbitrarily combined without conflict to obtain new method embodiments.

The features disclosed in the several apparatus embodiments provided by the present disclosure may be arbitrarily combined without conflict to obtain new apparatus or device embodiments.

The features disclosed in the several method or apparatus or device embodiments provided by the present disclosure may be arbitrarily combined without conflict to obtain new method or apparatus or device embodiments.

One of ordinary skill in the art may understand that all or part of the operations of the method embodiments may be implemented by a program instructing relevant hardware. The program may be stored in a computer readable storage medium, and may perform the operations of the method embodiments when executed. The storage medium may include a removable storage device, a read only memory (ROM), a magnetic disk, an optical disk, or any other medium that can store program codes.

In some embodiments, when being realized in form of software functional unit and sold or used as an independent product, the integrated units may be stored in a computer-readable storage medium. Based on such an understanding, the technical solutions of the present disclosure substantially or parts making contributions to the related art or part of the technical solutions may be embodied in form of software product, and the computer software product is stored in a storage medium, including multiple instructions configured to enable a computer device (which may be a personal computer, a mobile device or the like) to execute all or part of the operations of the method according to each of the embodiments of the present disclosure. The storage medium includes: various media capable of storing program codes, such as a removable storage device, a ROM, a magnetic disk or an optical disk or the like.

In the embodiments of the present disclosure, reference can be made to related descriptions of the same operation and the same content in different embodiments. In embodiments of the present disclosure, the term “and” does not affect the execution order of the operations.

Described above are merely specific embodiments of the present disclosure, however, the scope of protection of the present disclosure is not limited thereto, any variations or replacements apparent to those skilled in the art within the technical scope disclosed by the present disclosure shall fall within the scope of protection of the present disclosure. Therefore, the scope of protection of the present disclosure shall be subject to the scope of protection of the claims.

1. A method for image processing, comprising:
acquiring an image to be processed and respective semantic category information corresponding to each of a plurality of regions in the image to be processed, the respective semantic category information indicating at least one semantic category corresponding to the region;
acquiring a respective category mapping parameter corresponding to each of the at least one semantic category;
determining, based on the respective semantic category information corresponding to each region and the respective category mapping parameter corresponding to each semantic category, a region mapping parameter corresponding to the region; and
processing the image to be processed based on region mapping parameters corresponding to respective regions to obtain a processed image.

2. The method of claim 1, wherein determining, based on the respective semantic category information corresponding to each region and the respective category mapping parameter corresponding to each semantic category, the region mapping parameter corresponding to the region comprises:
for each region, responsive to determining that the semantic category information corresponding to the region indicates one semantic category corresponding to the region, determining, based on the category mapping parameter corresponding to the one semantic category, the region mapping parameter corresponding to the region.

3. The method of claim 1, wherein determining, based on the respective semantic category information corresponding to each region and the respective category mapping parameter corresponding to each semantic category, the region mapping parameter corresponding to the region comprises:
for each region, responsive to determining that the semantic category information corresponding to the region indicates a plurality of semantic categories corresponding to the region, acquiring, based on the semantic category information corresponding to the region, a respective confidence level corresponding to each of the plurality of semantic categories; and
determining, based on confidence levels corresponding to the respective semantic categories and category mapping parameters corresponding to the respective semantic categories, the region mapping parameter corresponding to the region.

4. The method of claim 1, wherein the region mapping parameter comprises at least one curve parameter arranged in order; and
processing the image to be processed based on the region mapping parameters corresponding to the respective regions to obtain the processed image comprises:
for each region, performing, based on the at least one curve parameter corresponding to the region, an iterative processing process on a sub-feature map to be processed corresponding to the region, wherein a number of curve parameters is the same as a number of iterations in the iterative processing process, and an output sub-feature map corresponding to any one of the iterations in the iterative processing process is an input sub-feature map corresponding to an iteration following the any one iteration; and
obtaining the processed image based on processed sub-feature maps corresponding to the respective regions, each of the processed sub-feature maps being a sub-feature map obtained by performing the iterative processing process on the sub-feature map to be processed corresponding to a respective region.

5. The method of claim 4, wherein the image to be processed corresponds to at least one image channel; and
performing, based on the at least one curve parameter corresponding to the region, the iterative processing process on the sub-feature map to be processed corresponding to the region comprises:
for any one of the iterations in the iterative processing process, determining, based on a curve parameter corresponding to the any one iteration, a respective sub-curve parameter corresponding to each of the at least one image channel;
determining, based on the respective sub-curve parameter corresponding to each image channel, a first mapping curve corresponding to the image channel;
converting, based on a respective first mapping curve corresponding to each image channel, an original attribute value of an input sub-feature map corresponding to the any one iteration for the image channel to obtain a target attribute value for the image channel; and
determining, based on the target attribute value for the at least one image channel, an output sub-feature map corresponding to the any one iteration.

6. The method of claim 4, wherein the image to be processed corresponds to at least one image channel; and
performing, based on the at least one curve parameter corresponding to the region, the iterative processing process on the sub-feature map to be processed corresponding to the region comprises:
determining, based on the at least one curve parameter corresponding to the region, at least one respective sub-curve parameter corresponding to each of the at least one image channel;
determining, based on the at least one respective sub-curve parameter corresponding to each image channel, at least one second mapping curve corresponding to the image channel; and
performing, based on at least one respective second mapping curve corresponding to each image channel, an iterative conversion process on an original attribute value of the sub-feature map to be processed for the image channel to obtain the processed sub-feature map corresponding to the region; wherein a number of sub-curve parameters is the same as a number of iterations in the iterative conversion process, and an output attribute value corresponding to any one of the iterations in the iterative conversion process is an input attribute value corresponding to an iteration following the any one iteration.

7. The method of claim 1, wherein acquiring the respective category mapping parameter corresponding to each of the at least one semantic category comprises:
performing feature extraction on the image to be processed to obtain an original feature map corresponding to the image to be processed;
determining, based on the respective semantic category information corresponding to each region and the original feature map, a respective category feature map corresponding to each semantic category; and
determining, based on the respective category feature map corresponding to each semantic category, the category mapping parameter corresponding to the semantic category.

8. The method of claim 1, wherein each of the plurality of regions comprises at least one pixel.

9. The method of claim 1, wherein the method is implemented by a trained image processing model.

10. An electronic device, comprising a memory and a processor, wherein
the memory is configured to store a computer program executable on the processor, and
the processor is configured to execute the computer program in the memory to implement the following operation comprising:
acquiring an image to be processed and respective semantic category information corresponding to each of a plurality of regions in the image to be processed, the respective semantic category information indicating at least one semantic category corresponding to the region;
acquiring a respective category mapping parameter corresponding to each of the at least one semantic category;
determining, based on the respective semantic category information corresponding to each region and the respective category mapping parameter corresponding to each semantic category, a region mapping parameter corresponding to the region; and
processing the image to be processed based on region mapping parameters corresponding to respective regions to obtain a processed image.

11. The electronic device of claim 10, wherein the processor is further configured to:
for each region, responsive to determining that the semantic category information corresponding to the region indicates one semantic category corresponding to the region, determine, based on the category mapping parameter corresponding to the one semantic category, the region mapping parameter corresponding to the region.

12. The electronic device of claim 10, wherein the processor is further configured to:
for each region, responsive to determining that the semantic category information corresponding to the region indicates a plurality of semantic categories corresponding to the region, acquire, based on the semantic category information corresponding to the region, a respective confidence level corresponding to each of the plurality of semantic categories; and
determine, based on confidence levels corresponding to the respective semantic categories and category mapping parameters corresponding to the respective semantic categories, the region mapping parameter corresponding to the region.

13. The electronic device of claim 10, wherein the region mapping parameter comprises at least one curve parameter arranged in order; and
the processor is further configured to:
for each region, perform, based on the at least one curve parameter corresponding to the region, an iterative processing process on a sub-feature map to be processed corresponding to the region, wherein a number of curve parameters is the same as a number of iterations in the iterative processing process, and an output sub-feature map corresponding to any one of the iterations in the iterative processing process is an input sub-feature map corresponding to an iteration following the any one iteration; and
obtain the processed image based on processed sub-feature maps corresponding to the respective regions, each of the processed sub-feature maps being a sub-feature map obtained by performing the iterative processing process on the sub-feature map to be processed corresponding to a respective region.

14. The electronic device of claim 13, wherein the image to be processed corresponds to at least one image channel; and
the processor is further configured to:
for any one of the iterations in the iterative processing process, determine, based on a curve parameter corresponding to the any one iteration, a respective sub-curve parameter corresponding to each of the at least one image channel;
determine, based on the respective sub-curve parameter corresponding to each image channel, a first mapping curve corresponding to the image channel;
convert, based on a respective first mapping curve corresponding to each image channel, an original attribute value of an input sub-feature map corresponding to the any one iteration for the image channel to obtain a target attribute value for the image channel; and
determine, based on the target attribute value for the at least one image channel, an output sub-feature map corresponding to the any one iteration.

15. The electronic device of claim 13, wherein the image to be processed corresponds to at least one image channel; and
the processor is further configured to:
determine, based on the at least one curve parameter corresponding to the region, at least one respective sub-curve parameter corresponding to each of the at least one image channel;
determine, based on the at least one respective sub-curve parameter corresponding to each image channel, at least one second mapping curve corresponding to the image channel; and
perform, based on at least one respective second mapping curve corresponding to each image channel, an iterative conversion process on an original attribute value of the sub-feature map to be processed for the image channel to obtain the processed sub-feature map corresponding to the region; wherein a number of sub-curve parameters is the same as a number of iterations in the iterative conversion process, and an output attribute value corresponding to any one of the iterations in the iterative conversion process is an input attribute value corresponding to an iteration following the any one iteration.

16. The electronic device of claim 10, wherein the processor is further configured to:
perform feature extraction on the image to be processed to obtain an original feature map corresponding to the image to be processed;
determine, based on the respective semantic category information corresponding to each region and the original feature map, a respective category feature map corresponding to each semantic category; and
determine, based on the respective category feature map corresponding to each semantic category, the category mapping parameter corresponding to the semantic category.

17. The electronic device of claim 10, wherein each of the plurality of regions comprises at least one pixel.

18. A non-transitory computer-readable storage medium, having stored thereon one or more programs that, when executed by one or more processors, cause the one or more processors to perform a method for image processing comprising:
acquiring an image to be processed and respective semantic category information corresponding to each of a plurality of regions in the image to be processed, the respective semantic category information indicating at least one semantic category corresponding to the region;
acquiring a respective category mapping parameter corresponding to each of the at least one semantic category;
determining, based on the respective semantic category information corresponding to each region and the respective category mapping parameter corresponding to each semantic category, a region mapping parameter corresponding to the region; and
processing the image to be processed based on region mapping parameters corresponding to respective regions to obtain a processed image.

19. The non-transitory computer-readable storage medium of claim 18, wherein determining, based on the respective semantic category information corresponding to each region and the respective category mapping parameter corresponding to each semantic category, the region mapping parameter corresponding to the region comprises:
for each region, responsive to determining that the semantic category information corresponding to the region indicates one semantic category corresponding to the region, determining, based on the category mapping parameter corresponding to the one semantic category, the region mapping parameter corresponding to the region.

20. The non-transitory computer-readable storage medium of claim 18, wherein determining, based on the respective semantic category information corresponding to each region and the respective category mapping parameter corresponding to each semantic category, the region mapping parameter corresponding to the region comprises:
for each region, responsive to determining that the semantic category information corresponding to the region indicates a plurality of semantic categories corresponding to the region, acquiring, based on the semantic category information corresponding to the region, a respective confidence level corresponding to each of the plurality of semantic categories; and
determining, based on confidence levels corresponding to the respective semantic categories and category mapping parameters corresponding to the respective semantic categories, the region mapping parameter corresponding to the region.
